(19) United States
(12) Patent Application Publication
(10) Pub. No.: US 2006/0249629 A1
(43) Pub. Date: Nov. 9, 2006

(54) Emergency system of airplane parachute with cushion

(76) Inventor: Yoo-I Lee, New Orleans, LA (US)

Correspondence Address: Yoo-i Lee, P. O. Box 531212, New Orleans, LA, 70153-1212, US

(21) Appl. No.: 11/044,623

(22) Filed: Jan. 28, 2005

(51) Int. Cl. B64D 17/00

(52) U.S. Cl. 244/139

(57) ABSTRACT

Emergency system of Airplane parachute with cusion means if airplane needs make a stop on the way or need temporary Landing on the way, This system work for Airplane can landing at Emergency on flying tinm. This parachute system are bringing Airplane from Flyingtime to Emergency Landing. and The Cusion system are makes Airplane Emergency Landing more safety. The Palachute string joint useing revolving, flexible and elasticy ly material. These system are Airplane can Landing on The Emergency way more Safety.

This invention that Emergency system Airplane parachute and cushion are at emergency time work parashute and cushion. These emergency system more safety make a forced Landing system. These parachute and cushion are might strong enough to keep Airplane body also speedly time so, as for parachute are use elasticly joint and about cushion use doubleness also three fold air layers. These navigability might enough power an capacity at emergency forced Landing at emergencytime. 1st object is human Life safety at Airplane flying time. if emergency happend on flying time, believe emergency system Airplane parachute and cushion Work.

### BACKGROUND OF THE INVENTION

Emergency system Airplane parachute and cusion is setting for every Airplane befor Flying, so when Airplane want to Emergency stop on the way, This system can Airplane bring Ground safety. Not only customers also Airplane selves. This system working maximum speed point are anytime one of very important Items.

However useing flexible, revolving and elasticly parachute string joint are very effective. If Airplane having Emergency Mobil Power, so this Emergency Landing system can bring Airplane more safe.

### FIELD OF THE INVENTION

This Invention relates Airplane flying time, when Emergency happenning occur So Airplane needs to safety stop quickly How can be done, means very effective this Emergency system of Airplane parachute and cusion,

When Airplane Emergency time, This parachute system can work Auto or handy so, Parachute will hold Airplane going to Emergency Landing slowly and safety also, cusion system can work Auto or Handy so, cusion will hold Airplane when Airplane Emergency Landing time more safety from an impact on The Ground or The Water.

### BRIEF DESCRIPTION OF THE DRAWING

Drawing Page No. 1

FIG. 1 are view from slanting high. working on make a force Landing.

FIG. 2 are view from The side. working on making a force Landing.

Drawing Page No. 2

FIG. 3 are view from top. working on making a force Landing.

FIG. 4 are view from Front. working on making a force Landing.

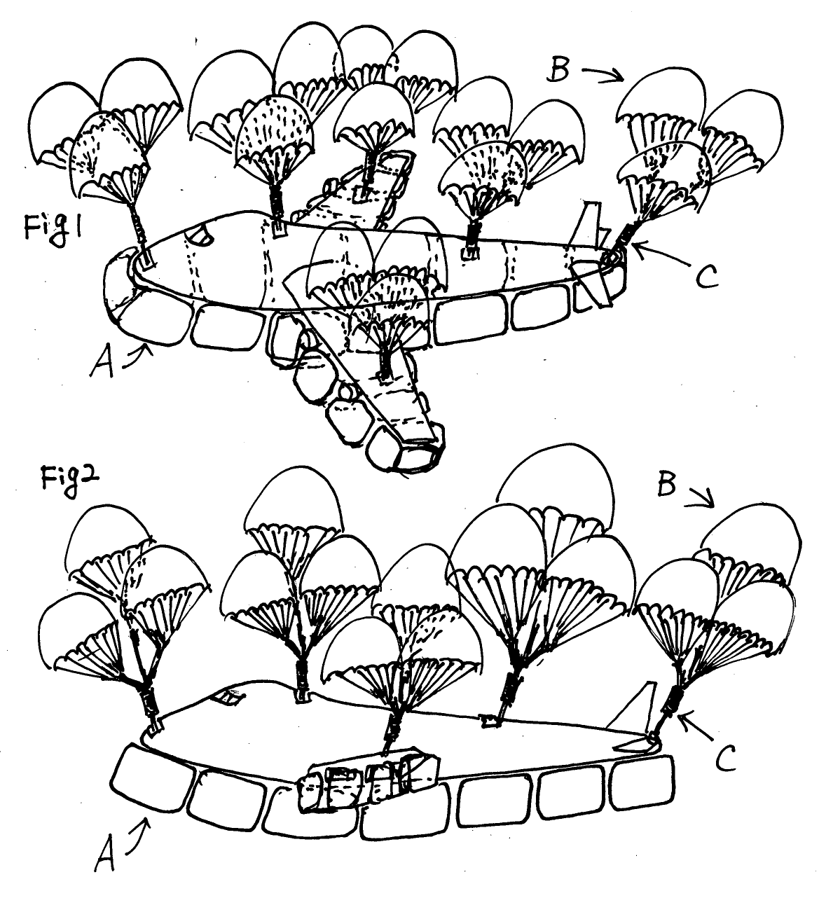

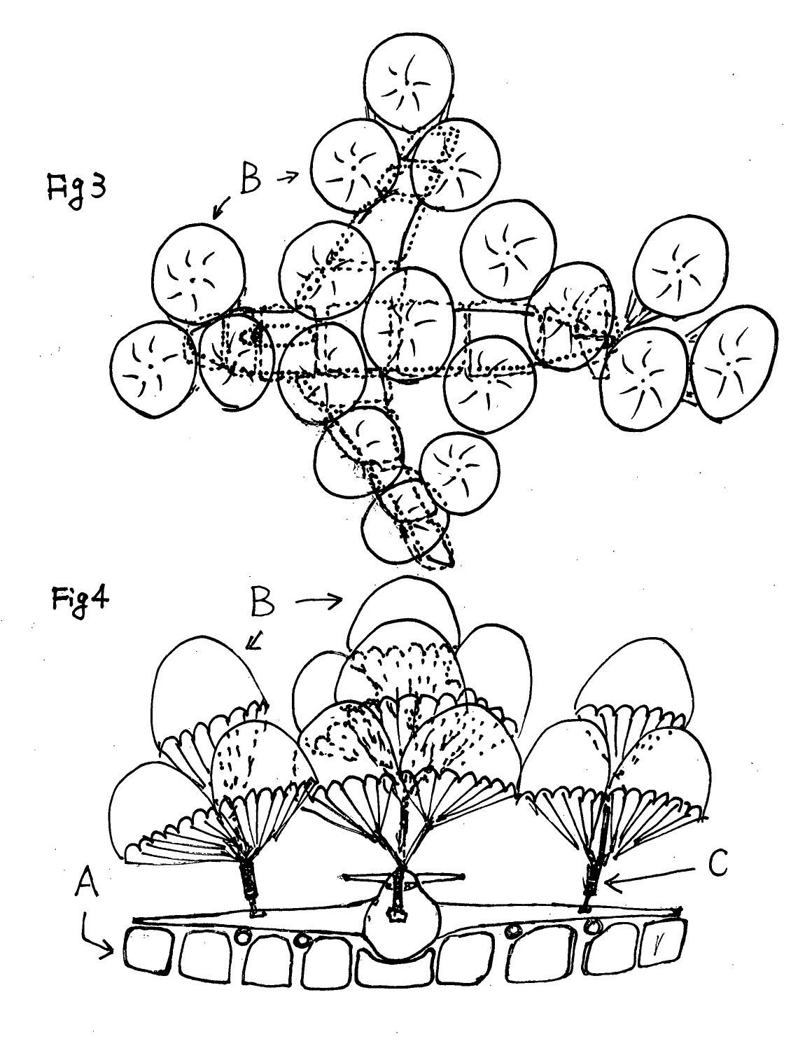

### DETAIL DESCRIPTION OF THE DRAWING

Drawing Page No. 1 and Drawing Page No. 2

A. means ready to Emergency Landing for cushion of Airplane.

B. means ready to Emergency Landing for parachute of Airplane.

C. means Emergency special parachute string joint.

1. This Invention that Emergency system Air Plane parachute with cushion are at emergency time Work Parachute and Cusion for every Airplane.
